(19) United States
(12) Patent Application Publication
(10) Pub. No.: US 2016/0196765 A1
(43) Pub. Date: Jul. 7, 2016

(54) System and method for attention training using electroencephalography (EEG) based neurofeedback and motion-based feedback

(71) Applicant: NeuroSpire, Inc., Durham, NC (US)

(72) Inventors: Jacob Stauch, Durham, NC (US); Jeroen Kools, Durham, NC (US); Pratheek Menon, Durham, NC (US)

(21) Appl. No.: 14/757,578

(22) Filed: Dec. 23, 2015

Related U.S. Application Data
(60) Provisional application No. 62/096,633, filed on Dec. 24, 2014.

(51) Int. Cl. G09B 19/00; G09B 5/02

(52) U.S. Cl. CPC G09B 19/00; G09B 5/02

(57) ABSTRACT

A multimodal neuro-feedback system utilizes a feedback loop that includes a combination of electroencephalography (EEG) based neuro-feedback, motion-based feedback, and a measurement of a user's performance at performing a go-no/go task as a protocol for attention-training therapy. Measurements of a user's brain activity, body movements, and cognitive performance are collected while the user interacts with a application program. The measurements are then processed and fed back into the application program in a feedback loop to control the execution and output of the application program. In turn, the user's observation of the output influences the user's interactions with the application program, and thus, subsequent measurements of the user's brain activity, body movements, and cognitive performance. Over time, the use of the feedback loop to control the application program improves the user's cognitive functioning and may be used to treat psychological or behavioral disorders.

### RELATED APPLICATIONS

This application claims the benefit of priority from U.S. Provisional Application Ser. No. 62/096,633 filed Dec. 24, 2014, and entitled “System and Method for Attention Training Using Electroencephalography (EEG) Based Neurofeedback and motion-Based Feedback,” the contents of which are incorporated herein by reference in their entirety.

### FIELD OF THE DISCLOSURE

The present disclosure relates generally to computing devices, and particularly to computing devices configured for improving cognitive functioning, and/or treating psychological or behavioral disorders.

### BACKGROUND

Attention Deficit Hyperactivity Disorder (ADHD) is probably one of the most commonly recognized learning disorders. Its symptoms include inattentiveness, hyperactivity, and impulsivity, and can interfere with a person's ability to function at school, work, and home. According to some estimates, more than 10% of all children have been diagnosed with this condition.

Over the past decade, ADHD diagnoses have grown exponentially. However, treatment options have remained relatively stagnant, with two-thirds of diagnosed children, and an overwhelming 3% of the United States population, taking stimulant drugs like Adderall® and Ritalin®. These stimulants are Schedule II controlled substances and carry a high risk of dependency. Further, these drugs are associated with side effects that include appetite loss, facial tics, paranoia, suicidal thoughts, and even sudden death.

### SUMMARY

The present disclosure provides a system and method for improving cognitive functioning, and/or treating psychological or behavioral disorders/deficits, such as ADHD. In one embodiment, a computing device communicatively connected to one or more sensors executes an application program. While the user interacts with the application program, the sensors detect and measure the user's brain activity and motion. Based on these measurements, the computing device computes an attention score and a motion score, respectively, for the user. The attention score quantifies the user's level of attention while interacting with the computing program, while the motion score quantifies the amount of user motion or movement (e.g., fidgeting) while interacting with the application program. These scores are then fed into the application program as input parameters in a feedback loop to control the execution of the application program and provide feedback to the user.

In one embodiment, the present disclosure provides a computer-implemented method for treating a psychological or behavioral disorder. The method comprises executing a video game application on a computing device, wherein the video game application generates a virtual environment for display to a user, and one or more objects that are controllable by the user within the virtual environment. While the user interacts with the video game application, the method comprises receiving neurofeedback indicating the user's concentration level while the user is controlling the one or more objects, receiving motion feedback indicating the user's motion while the user is controlling the one or more objects, and while the user is controlling the one or more objects, determining the user's performance on one or more go/no-go tasks generated by the video game application. The go/no-go tasks distract the user from concentrating on controlling the one or more objects. The method then calls for generating input parameters for the video game application based on the neurofeedback, the motion feedback, and the user's performance on the one or more go/no-go tasks, and inputting the input parameters into the video game application, wherein the input parameters control the one or more objects to train the user to remain focused, to remain motionless, and to control impulsivity, while controlling the one or more objects.

In another embodiment, the present disclosure provides a computing device configured for treating a psychological or behavioral disorder. The computing device comprises a communications interface circuit and a processing circuit. The communications interface circuit is configured to receive neurofeedback and motion feedback for a user from corresponding first and second sensor devices. The processing circuit is configured to execute a video game application, wherein the video game application generates a virtual environment for display to a user, and one or more objects that are controllable by the user within the virtual environment. While the user interacts with the video game application, the processing circuit is further configured to receive the neurofeedback indicating the user's concentration level while the user is controlling the one or more objects, receive the motion feedback indicating the user's motion while the user is controlling the one or more objects, and while the user is controlling the one or more objects, determine the user's performance on one or more go/no-go tasks generated by the video game application. The go/no-go tasks distract the user from concentrating on controlling the one or more objects. The processing circuit is further configured to generate input parameters for the video game application based on the neurofeedback, the motion feedback, and the user's performance on the one or more go/no-go tasks, and input the input parameters into the video game application, wherein the input parameters control the one or more objects to train the user to remain focused, to remain motionless, and to control impulsivity, while controlling the one or more objects.

In another embodiment, the present disclosure provides a computer-implemented method for treating a psychological or behavioral disorder while the user interacts with a video game application executing on a computing device. Particularly, the video game application generates a virtual environment for display to a user and one or more objects that are controllable by the user within the virtual environment.

While the user is controlling the one or more objects, the method calls for receiving neurofeedback from a first sensor device indicating the user's concentration level, receiving motion feedback from a second sensor device indicating the user's motion while the user is controlling the one or more objects, and determining the user's performance on one or more go/no-go tasks generated by the video game application. The go/no-go tasks distract the user from concentrating on controlling the one or more objects. The method also calls for generating input parameters based on the neurofeedback, the motion feedback, and the user's performance on the one or more go/no-go tasks, and inputting the input parameters into the video game application, wherein the input parameters control the one or more objects to train the user to remain focused, to remain motionless, and to control impulsivity, while controlling the one or more objects.

In another embodiment, the present disclosure provides a computer-implemented method for treating a psychological or behavioral disorder while the user interacts with a video game application executing on a computing device. The video game application generates a virtual environment for display to a user and one or more objects that are controllable by the user within the virtual environment. In this embodiment, while the user is controlling the one or more objects, the method calls for receiving motion feedback from a sensor device indicating the user's motion, and determining the user's performance on one or more go/no-go tasks generated by the video game application. The go/no-go tasks distract the user from concentrating on controlling the one or more objects. The method then calls for generating input parameters based on the motion feedback and the user's performance on the one or more go/no-go tasks, and inputting the input parameters into the video game application, wherein the input parameters control the one or more objects to train the user to remain motionless, and to control impulsivity, while controlling the one or more objects.

Of course, those skilled in the art will appreciate that the present disclosure is not limited to the above contexts or examples, and will recognize additional features and advantages upon reading the following detailed description and upon viewing the accompanying drawings.

### BRIEF DESCRIPTION OF THE DRAWINGS

FIG. 1 is a perspective view of a system configured according to one embodiment of the present disclosure.

FIGS. 2A-2B are perspective views of a graphical user interface (GUI) configured according to one embodiment of the present disclosure.

FIG. 3 is a flow diagram illustrating a method for providing attention-training according to one embodiment of the present disclosure.

FIG. 4 is a flow diagram illustrating a method for providing attention-training according to one embodiment of the present disclosure.

FIG. 5 is a perspective view illustrating the system configured according to another embodiment of the present disclosure.

FIG. 6 is a functional block diagram illustrating some functional components of an EEG device and a computing device according to one embodiment of the present disclosure.

### DETAILED DESCRIPTION

The present disclosure provides a device and method for attention training utilizing a multimodal neuro-feedback system. More particularly, the present disclosure provides a system that utilizes a combination of electroencephalography (EEG) based neuro-feedback, motion-based biofeedback, and in some embodiments, a measurement of a user's performance at performing a go-no/go task as a protocol for attention-training therapy. Beneficially, embodiments of the present disclosure address inattentiveness, hyperactivity, and impulsivity, as well as other symptoms of various behavioral disorders.

According to embodiments of the present disclosure, the multimodal neuro-feedback system comprises an EEG device and a motion sensor, both of which may be worn by the user, and a computing device that interfaces with both the EEG device and the motion sensor. The EEG device measures the user's brain activity while the user interacts with an application program, such as a computer game, executing on the computing device. The motion sensor detects whether the user is moving while the user interacts with the application program. A control application executing on the computing device receives the signals generated by both the EEG device and the motion sensor, computes data values based on processing the signals, and feeds those data values back into the application program to control the execution and output of the application program. In some embodiments, the functions of the control application are integrated into the application program. In turn, the user's observation of the output influences the user's interactions with the application program, and thus, affects subsequent measurements of the user's brain activity, body movements, and cognitive performance.

Thus, the user can adjust his/her behavior (i.e., cognitive activity and/or motion) based on the output of the application program. For example, based on the output, the user may focus more intently on a task or not move around as much. The EEG device and motion sensors detect this adjusted behavior, and send signals indicating the adjusted behavior to the control application, which then feeds data values based on those signals back into the application program. The application program then provides the user with updated feedback with which the user can continue to alter their behavior. Thus, embodiments of the present disclosure generate a feedback loop that trains the user to maintain his or her attention and focus on a particular task. Additionally, the computing device is configured to provide the users and others, such as their therapists, teachers, parents, or other supervisors, an insight into the user's performance and progress.

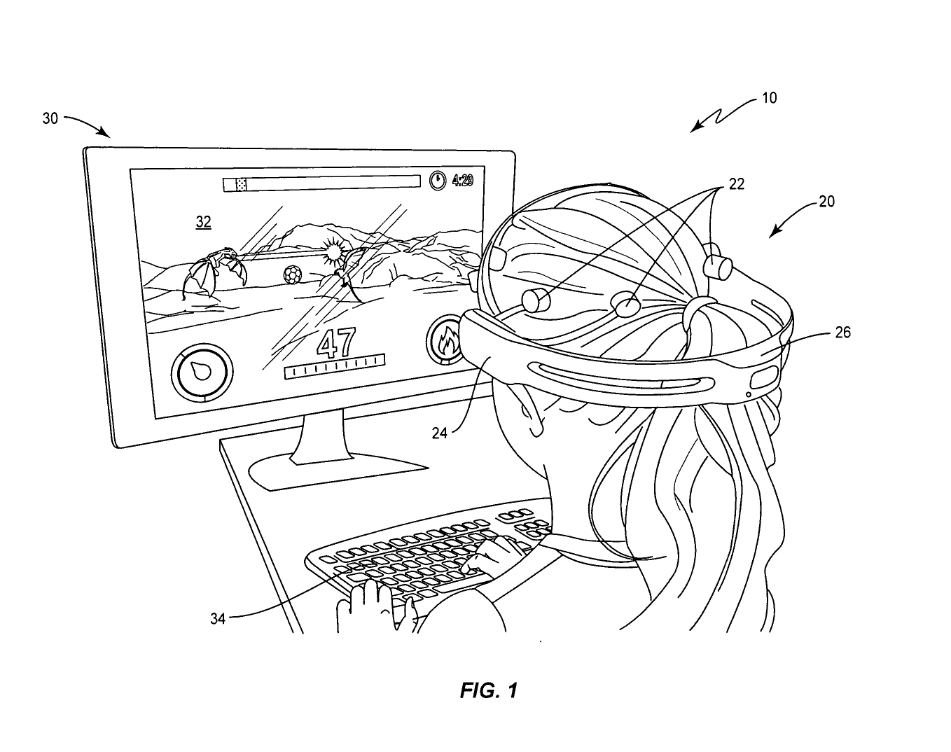

Turning now to the drawings, FIG. 1 is a perspective view showing the components of a multimodal neuro-feedback system 10 configured according to one embodiment of the present disclosure. As seen in FIG. 1, system 10 comprises an integrated EEG device/motion-sensing device 20 and a computing device 30 that executes a video game for the user to play.

The EEG device 20 is generally configured to measure a user's brain activity and comprises one or more electrical sensors 22, motion sensors 24, and in this case, a wireless communications interface 26. In this embodiment, the EEG device 20 is a headset that is worn by the user. However, those of ordinary skill in the art should readily appreciate that this is for illustrative purposes only, and that the present disclosure is not so limited. In other embodiments, for example, the EEG device 20 may be a helmet, a cap, or headband. Additionally or alternatively, the motion sensors 24 may be comprised in a separate device. Regardless of its particular structure, however, the EEG device 20 comprises a plurality of embedded or removable electrical sensors 22 configured to measure the user's brain activity. The sensors 22 may use an electrolyte gel or paste to conduct electrical signals from the user's skin (e.g., the user's scalp) to the sensor. Alternatively, sensors 22 may be a type of dry sensor configured to directly contact the user's skin.

In operation, the EEG device 20 obtains electrical potential measurements representing the user's brain activity from the sensors 22, and sends signals representing those measurements in digitized batches to a control application executing on the computing device 30. The EEG device 20 also measures the electrical impedance of the sensors 22 as a measure of contact quality, and in some embodiments, is configured to filter out interference from the signals generated by the sensors 22 before those signals are communicated to the computing device 30. Such interference includes, but is not limited to, AC interference generated by nearby power lines and electronic equipment, for example.

As described in more detail later, the control application executing on the computing device 30 continuously processes these received signals, and based on that processing, generates an “attention score.” This attention score can then be used by the control application as input into the video game being played by the user, or into some other computer interface. This is done to reward the user for increased attentiveness and focus on a particular task, or to penalize the user for decreased attentiveness and focus, and thereby trains the user to reduce inattentiveness, a typical ADHD symptom.

As the sensors 22 are measuring and reporting the user's brain activity, the motion sensor 24 is measuring and reporting signals that represent the user's physical motion. The signals representing the user's motion, like those from sensors 22, are also sent to the control application executing on computing device 30. As described in more detail later, the control application continuously processes the signals received from the motion sensor 24, and based on those signals, generates a “motion score.” This motion score can then be used as input into the video game being played by the user, or into some other computer interface. This is done to reward users for sitting still and exhibiting self-control, and to penalize users that do not sit still or fidget. As with the neurofeedback provided by sensors 22 above, this motion-based feedback trains users to reduce hyperactivity, another typical ADHD symptom.

The motion sensor 24 may comprise any sensor known in the art capable of detecting and recording the user's motion. For example, motion sensors 24 on the EEG device 20 may comprise an accelerometer, a gyroscope, or other sensor configured to detect the user's head movements. In other embodiments, however, the motion sensor 24 may be a webcam implemented at the computing device 30. In these latter cases, the motion sensor 24 may be configured to monitor the movement (or lack of movement) of the user's eyes and/or head while the user plays a game on computing device 30. In some embodiments, the motion sensor 24 comprises a combination of such circuitry disposed at one or both of the EEG device 20 and the computing device 30.

In this embodiment, the EEG device 20 also comprises a wireless transceiver 26 capable of establishing a short-range communications link with a corresponding short-range transceiver on computing device 30. In these cases, the short-range transceiver 26 receives the signals from sensors 22, 24, and communicates those signals with the computing device using any communications protocol known in the art. Such protocols include, for example, BLUETOOTH, InfraRed, Near Field Communication (NFC), and WiFi. In other embodiments, however, the transceiver comprises circuitry configured to transmit and receive the signals over a cable or wire connecting the EEG device 20 to computing device 30.

Computing device 30 comprises a display device 32 and a user input device, such as a keyboard 34. As stated above, a control application executing on the computing device 30 configures the computing device 30 to receive the signals from sensors 22, 24, and to utilize the incoming signals to train the user to maintain his or her attention on a particular task. As seen in more detail below, the task may be, for example, a task associated with playing a video game on computing device 30.

In more detail, the control application executing at computing device 30 receives the signals from the sensors 22, 24 over multiple sensor channels. The signals received over each sensor channel are converted by the control application into the frequency domain using, for example, a Fourier transformation at set intervals. After an initial calibration sequence that determines a user's individual peak alpha frequency, the control application bins the frequencies into the alpha, beta, delta and theta EEG wavebands. By adjusting the traditional alpha, beta, delta and theta EEG waveband ranges to the individual user, system 10 of the present disclosure is more robust for users of various ages, brain volumes, and other natural variations.

The control application executing at the computing device 30 then extracts features relevant to the current attention state of the user as a combination of waveband scores of specific sensors 22, resulting in a real-time, accurate “attention score” that can be sent or referenced as an input parameter into the video game or other computer program along with the “motion score” information measured by sensors 24 and representing the user's physical motion or movement. Coupling the attention score and/or the motion score to success, speed, strength, or another desirable quality in a game or training scenario is a psychological reinforcement of the attentive behavior, thus serving as the basis of the neuro-feedback and motion feedback mechanisms.

Additionally, in some embodiments, the user is also presented with a “go/no-go” type of task by the application program. Specifically, the application program, which by way of example may be a video game or an application configured to test the user on a go/no-go task. Such tasks require the user to make quick sequential decisions on whether or not to take a specific action, such as to press a button when a green light is displayed, but not when a red is displayed. Performance on this go/no-go task, measured in hits and misses of both the positive and the negative stimulus, is converted by the control application into a single accuracy metric. This metric, which may, for example, be a ratio of hits to misses, measures an “impulsivity score” of the user and further improves the feedback mechanism.

As seen in FIG. 1, the display device 32 displays a user interface (UI) that gives the user ongoing feedback on their attention, motion, and impulsivity scores. According to the present disclosure, the user can utilize the feedback to train his or her attention by trying to maximize their attention score (i.e., by entering into brain states associated with high focus as measured by sensors 22), minimizing their motion score (i.e., by reducing hyperactivity as measured by sensor 24), and by learning to control their impulsivity as a function of succeeding at the various go/no-go tasks.

The UI may be associated with a video game that is being played by the user. For example, with the game seen on display device 32 in FIG. 1, users must raise their attention score above a certain threshold, and maintain their motion score below another threshold, which are calibrated to their average attention score from previous sessions. Thus, users advance through the game by focusing on the tasks at hand, sitting extremely still, and controlling their impulsivity.

In more detail, the object of the game for the user, in this embodiment, is to make a dragon avatar fly higher and faster. In operation, the game receives the signals from sensors 22, 24, and based on those signals, provides positive feedback to the user when the user expresses brain activity associated with greater attentiveness and less frequent body movements. Thus, if the user's attention score is maintained at or above a predetermined attention threshold value (indicating that the user is maintaining focus), and the user's motion score is below a predetermined motion threshold value (indicating that the user is still), the dragon avatar rises higher and flies faster. Similarly, the game provides negative feedback to the user for expressing brain activity that is associated with inattentiveness and/or excessive body movements. For example, if the attention score dips below the predetermined attention threshold value (indicating that the user is losing focus), and/or their motion score exceeds the predetermined motion threshold value (indicating that the user is moving around too much), the dragon avatar falls rapidly.

Thus, embodiments of the present disclosure provide a feedback loop in which measurements of the user's brain activity, body movements, and cognitive performance are utilized as input to the application program to control the execution and output of the video game (e.g., whether the dragon avatar flies high and fast, or falls rapidly). The user's observation of the output influences the user's subsequent interactions with the video game, and thus, affects the subsequent measurements of the user's brain activity, body movements, and cognitive performance. This feedback loop may, over time, lead to lasting improvements in cognitive functioning and in the treatment of psychological or behavioral disorders such as ADHD and other attention disorders.

In some embodiments, the computing device 30 also establishes a communications link with a local or centralized server device that tracks the progress of users and their sessions in a user profile. Session data might include averaged scores, histograms of values, the full record of data, and the like. Further, profiles can store other information such as user identities and the times and dates of their training sessions. This information can be retrieved by the control application executing on the computing device 30 to personalize and adapt training for each user to their current skill level, and to provide a gradual learning curve. The profile can also be accessed online by the user, a guardian, or supervisor, for example, to allow those people to review and monitor various visualizations of performance, activity, and improvements of the user's scores and metrics over a period of time.

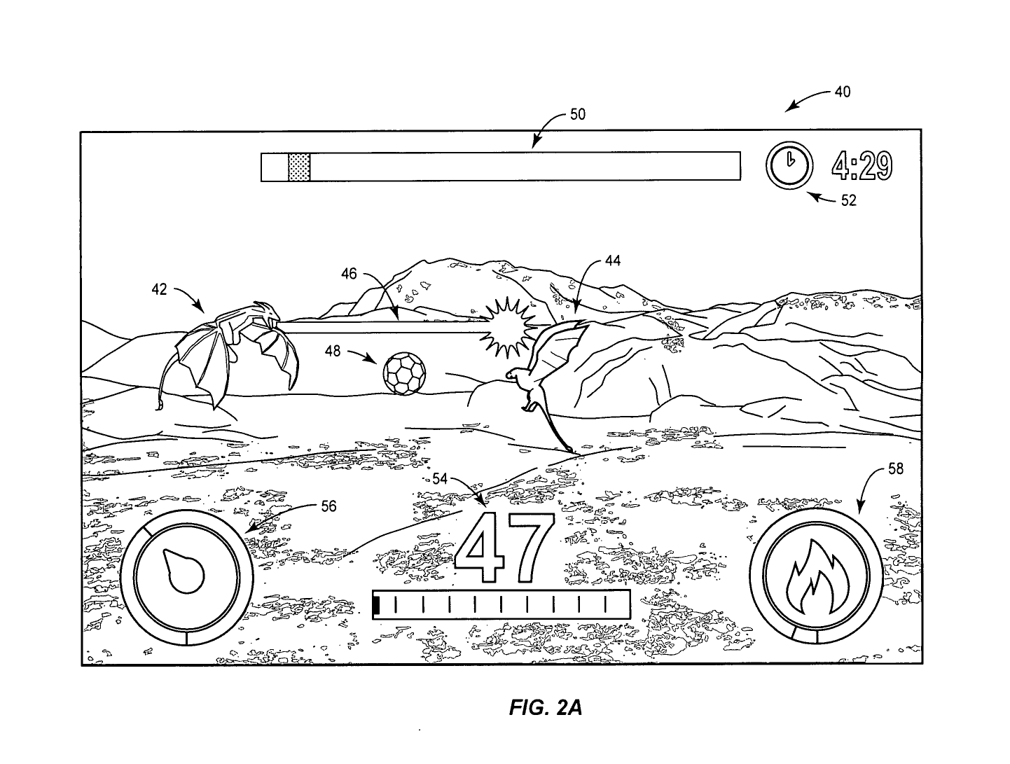

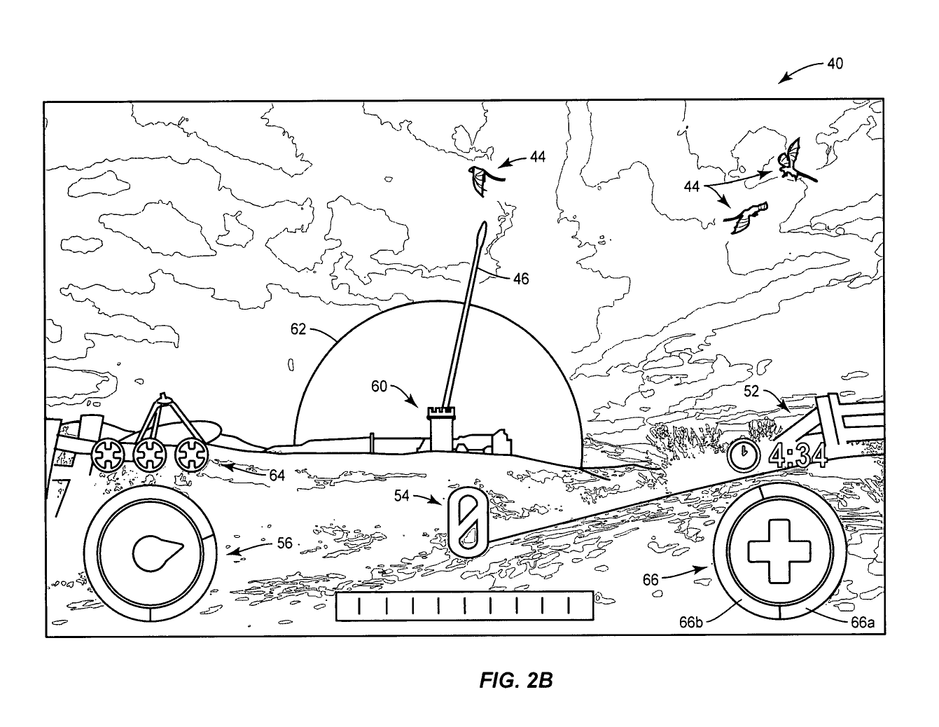

FIGS. 2A-2B illustrate a user interface 40 for a video game controlled according to one embodiment of the present disclosure. As stated above, the video game executes on computing device 30 and processes the neurofeedback and motion feedback signals received from EEG device 20. Additionally, the video game provides various go/no-go tasks for the user to address during game play. As described in more detail below, various video game functions, as well as the controls seen on the interface 40, are controlled based on the processing of the received feedback signals. The video game output, such as the various scores and activity of the controlled video game functions, for example, helps train the user to remain focused on a task, to remain as still as possible, and to control their own impulsivity. In addition, in some embodiments of the present disclosure, the video game output can also be used in a feedback loop as input into the video game to complement the neuro-based and motion-based feedback signals received from the EEG device 20, as well as the user's measured performances on the go/no-go tasks.

As seen in FIG. 2A, this embodiment of interface 40 comprises a pair of dragon avatars 42, 44, a projectile 46, which in this case is fire, a mine 48, a progress bar 50, a timer 52, a scoreboard 54, a focus meter 56, and a turbo meter 58. Those of ordinary skill in the art will readily appreciate that the particular aspects of interface 40 seen in the figures are for illustrative purposes only, and that interface 40 may comprise more or fewer components, or different components, than are illustrated. Further, other application programs, which may or may not be game-related, may also be configured according to embodiments of the present disclosure to provide a corresponding interface that facilitates the attention training, hyperactivity training, and impulsivity training as described herein.

In this embodiment of the present disclosure, the user controls the dragon avatar 42 to fly through an imaginary world based on the neuro-based and motion-based feedback provided by EEG device 20. Particularly, the neurofeedback provided by EEG device 20 is processed by computing device 30 and used to control the speed of the dragon avatar 42. For example, one embodiment of the present disclosure determines a beta/theta ratio for a user based on the neurofeedback signals provided by the EEG device 20. This ratio is an indication as to the user's level of focus or concentration. The higher the beta/theta ratio, the higher the user's concentration level and the faster the dragon avatar 42 will fly. The lower the beta/theta ratio, the lower the user's concentration level and the slower the dragon avatar 42 will fly. To determine whether the dragon avatar 42 will fly faster or slower, the beta/theta ratios may be periodically compared to one or more threshold values.

It should be understood that the use of a beta/theta ratio as an indicator of the user's concentration level is but one example, and that the present disclosure is not limited solely to use of this protocol. In other embodiments, for example, the present disclosure may determine the user's concentration level based on whether the user's beta frequencies fall within a targeted narrow range of frequencies in the beta waveband. Alternatively, or additionally, embodiments of the present disclosure may determine the user's concentration level utilizing one or more other frequencies that are not within the beta and/or theta wavebands.

Similarly, the motion feedback provided by EEG device 20 is processed by computing device 30 and used to control the stability of the dragon avatar 42. As above, the signals provided by the EEG device 20 regarding user movements may be compared to one or more threshold values. If the signals from EEG device 20 indicate that the user is exhibiting excessive movement (e.g., fidgeting, head movement, etc.), the dragon avatar 42 may be controlled to shake and/or to slow down. Additionally, or alternatively, a background color of the interface 40 may change to exhibit a reddish tint. If the signals from the EEG device 20 indicate that the user remains relatively still, however, the dragon avatar 42 may be controlled to fly faster and/or to remain stable.

In some embodiments, the predetermined threshold values against which the neurofeedback and/or motion feedback signals are compared may be dynamically adapted in accordance with the user's history. Particularly, the user's ability to remain focused and/or still during game play is continually measured and captured (e.g., via scores). These scores may then be used to subsequently alter one or more of the threshold values. If the user's scores indicate an increased focus by the user, and/or the user is remaining relatively still, the threshold values may be increased. If the user's scores indicate a decreased focus, and/or the user's movement is excessive, the, threshold values may be decreased. While this may make the game more difficult for the user to play, it will also reinforce the behaviors needed for the user to maintain an increased focus and combat hyperactivity. It also provides other interested persons (e.g., parents, doctors, etc.) with information that indicates the user's ability to focus their attention and remain still.

The other dragon avatar 44 represents a plurality of dragon avatars 44 that enter the interface 40 from the right. An object of the game is for the user to control the dragon avatar 42 using a mouse or keyboard to fire a projectile 46 (e.g., a stream of fire) at an avatar 44. However, in one embodiment, avatars 44 are classified as either “good” or “bad.” This classification may be portrayed to the user by using one color to visually indicate “good” avatars 44 (e.g., green) and another different color to visually indicate “bad” avatars 44 (e.g., red). This represents a “go/no-go” type of task to shoot and kill the “bad” avatars 44, while ignoring the “good” avatars 44 and allowing them to fly past. Points are awarded for successfully shooting the “bad” avatars 44, and/or for not shooting the “good” avatars 44. Additionally, points may be deducted for shooting the “good” avatars 44, and/or for not shooting the “bad” avatars 44.

This type of task is a “go/no-go” task that measures the user's ability to quickly and accurately respond to various stimuli. The better the user does in discerning between good and bad avatars 44, and in successfully shooting and/or not shooting the avatars 44 based on that determination, the more points the user scores. Additionally, the difficulty of the go/no-go task may increase with the score of the user. That is, the better the user does, the harder the go/no-go tasks become. For example, a simple distractor, such as mine 48, for example, may enter the interface 40 from the right during game play. The idea is to provide the user with something else to think about while concentrating on shooting the bad avatars 44. The goal with a mine 48 is to either avoid the mine 48 as it flies past, or to detonate the mine 48 before it contacts the user's dragon avatar 42. By way of example only, the user may click on the mine 48 to cause it to explode. Successfully navigating or destroying the mine 48 results in an increased point score for the user, while unsuccessfully navigating the mine 48 or failing to destroy mine 48 may cause points to be deducted from the user.

As previously stated, interface 40 provides multiple controls and indicators to keep the user appraised as to his/her performance at the video game. Each control or indicator is related, directly or indirectly, to the user's neurofeedback, the user's motion feedback, and the user's success/failure at the various go/no-go tasks.

As seen in FIG. 2A, for example, the progress bar 50 indicates the user's progress in the current level. In some embodiments, the user may only have a predetermined amount of time to successfully complete a given level (e.g., 5:00 minutes), which may be indicated using timer 52. In these cases, the present disclosure considers the progress of the user through the current level with respect to the allotted time, and then changes the appearance of the progress bar 50 to indicate whether the user is on schedule or ahead of schedule. By way of example only, the progress bar 50 may appear green to indicate that the user is on schedule and will complete the level on time or before the allotted time expires, or red to indicate that the user is behind schedule and will not complete the level before the allotted time expires.

The point indicator 54 displays the user's current score. As previously stated, points may be awarded, for example, for successfully shooting down “bad” avatars 44 (and not shooting down “good” avatars 44), successfully navigating or destroying mines 48, successfully completing a level, and remaining focused and still as indicated by the neurofeedback and motion feedback measured by sensors 22, 24 at EEG device 20. Points may be deducted, however, for shooting down “good” avatars 44 (and not shooting down “bad” avatars 44), not destroying a mine 48, and by failing to remain focused and motionless as indicated by the neurofeedback and motion feedback measured by sensors 22, 24 at EEG device 20.

The focus indicator 56, in this embodiment, is a “speedometer” type of indicator that indicates a measure of the user's current level of focus. As stated previously, the focus may be determined based on a beta/theta ratio of the user. The focus indicator 56 is dynamically updated during game play based on the neurofeedback provided by EEG device 20, and thus, will generally fluctuate as that ratio increases (i.e., to show increased focus) and decreases (i.e., to indicate decreased focus).

The turbo meter 58 indicates the user's progress in being able to activate the video game's “turbo mode.” Particularly, when activated, the turbo mode provides the user's dragon avatar 42 with an increased burst of speed for a predetermined length of time. Initially, the turbo meter 58 indicates that no progress has been made towards the turbo mode by the user. However, progress can be made by the user towards the turbo mode by showing an increased focus level for an extended period of time. Decreased focus levels may decrease that progress. When the turbo meter 58 indicates that the turbo mode is ready, the user activates the turbo mode via a keystroke or mouse, for example. The turbo meter 58 is then updated to indicate the use of the turbo mode, and the user can once again make progress towards a subsequent use of the turbo mode through increased focus.

As previously stated, the present embodiments may provide the video game with a plurality of different levels, with each higher level being more difficult for the user. For example, the time that the user has to complete a level may be reduced, the number, speed, and trajectories of the “good” and/or “bad” avatars 44 may be increased and/or varied, the number, speed, and trajectories of various obstacles (e.g., mines 48) may be increased and/or altered, and the like.

Additionally, in some embodiments, the different levels of the video game are configured to train the user using different sets of capabilities. For example, FIG. 2A illustrates one level in which the user must fly his/her dragon avatar 42 through the imaginary world while avoiding bad dragon avatars 44 and mines. FIG. 2B, however, illustrates another different level of the video game in which the user controls a weapon positioned in a town 60 to shoot the “bad” dragon avatars 44 while ignoring the “good” dragon avatars 44. The object of this level is to protect the town 60 from being destroyed by “bad” avatars 44 for a predetermined length of time (e.g., 5 minutes), indicated by timer 54.

In this embodiment, the town 60 is protected by a shield 62, the diameter of which is controlled using the neurofeedback from EEG device 20 (e.g., the beta/theta ratio). Thus, shield 62 grows larger and/or stronger (e.g., is recharged) whenever the neurofeedback indicates an increased focus by the user, but grows smaller and/or weaker whenever the neurofeedback indicates that the user's concentration lapses. The shield 62 may also grow smaller and/or weaker whenever the shield 62 is hit by an incoming projectile from one or more of the “bad” avatars 44.

As with the previous level seen in FIG. 2A, the user may shoot the bad avatars 44 utilizing the mouse or keypad to launch projectiles 46. Hits on the “bad” avatars 44 awards the user points, reflected on point meter 54, while accidental hits on “good” avatars 44 may cause a point deduction. For this embodiment, the interface 40 also provides a set of crosshair indicators 64, which indicate the number of remaining projectiles 46 that are available to the user, and a health meter 66. The number of projectiles 46 available to the user are increased and decreased as a function of the user's motion. Specifically, the user will receive additional projectiles 46 by remaining still, but will lose projectiles 46 when excessive motion is detected. As stated above, such motion, or lack of motion, is measured using sensors 24 on the EEG device 20.

The health meter 66 in this embodiment has two components—a shield health meter 66a and a town health meter 66b. Particularly, the shield health meter 66a indicates the health of the shield 62 that protects town 60. A high level of focus for the user causes the shield health meter 66a to indicate increased health for shield 62, while loss of focus causes the shield health meter 66a to indicate a decreased health for shield 62. The town health meter 66b indicates the health of the town 60. When “bad”avatars 44 shoot rockets at town 60 and shield 62 is low, the town 60 takes damage. The town health meter 66b thereby reflects this damage and, when the town health meter 66b is at zero, the user has lost the level.

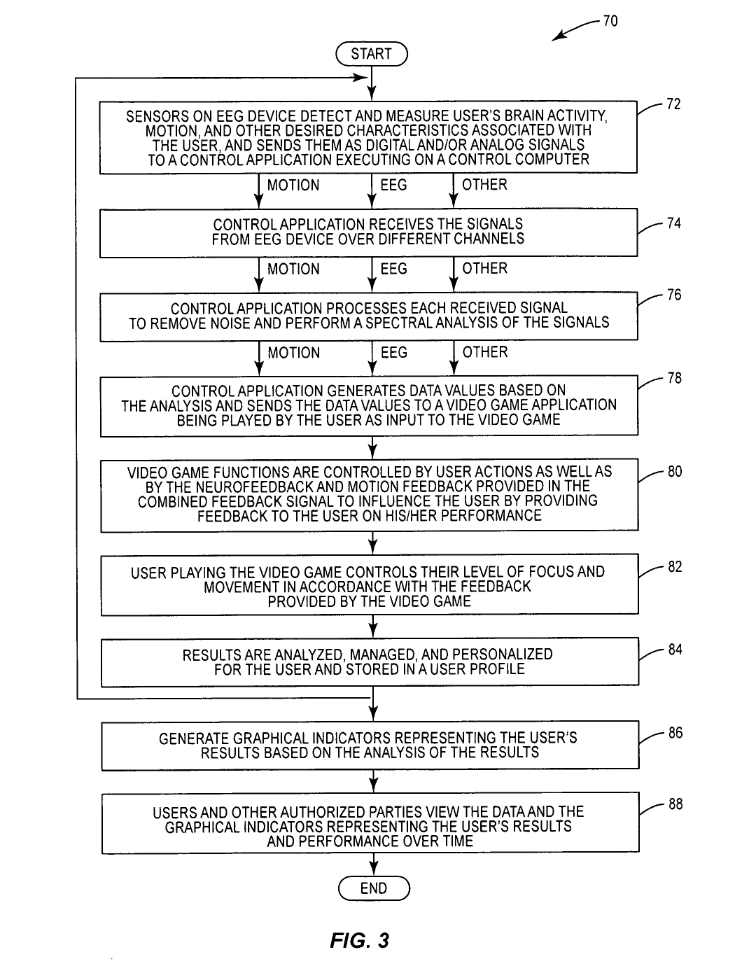

FIG. 3 is a flow diagram illustrating a method 70 for performing attention training using a feedback loop comprising EEG-based neurofeedback and motion-based feedback in accordance with one or more embodiments of the present disclosure. More particularly, a control application executes on computing device 30, for example, and is in communication with a video game being played by the user. In this embodiment, the control application implements method 70 to collect the neurofeedback and the motion-based feedback associated with a user, and sends that feedback to the video game. The video game then utilizes that feedback to train the user to address his or her inattentiveness, hyperactivity, and impulsivity, as well as address the symptoms of various behavioral disorders.

Method 70 assumes that a user is performing an activity, such as playing the video game, for example, that uses the signals generated by EEG sensors 22 and motion sensors 24. However, those of ordinary skill in the art should readily appreciate that the present disclosure may utilize signals from other types of sensors that may be used as input to some other type of computing-based user activity.

Method 70 begins with the EEG sensors 22 and the motion sensors 24 on EEG device 20 detecting and measuring the user' brain activity and motion, and then outputting respective signals based on the measurements of the user's brain activity, and the user's motion (or lack of motion) to the computing device 30 (box 72). In addition, the EEG device 20 may provide other signals from other sensors to computing device 30. The signals may be digital signals or analog signals. Upon receipt of the signals at computing device 30, which as seen in FIG. 3 may be on different channels (box 74), the control application executing on the computing device 30 controls a processing circuit at the computing device 30 to process the signals (box 76).

For example, the control application may control the processing circuit to perform a spectral analysis on the signals, and filter the incoming signals to remove noise utilizing, for example, an algorithm that employs a sliding window. Additionally or alternatively, the control application may control the processing circuit to compute real-time neurofeedback and motion-based metrics from the processed signals (e.g., the attention and motion scores), and provide those computed values as input to the video game being played by the user on computing device 30 (box 78). According to the present embodiments, any known algorithms or methods may be used to perform the spectral analysis and filtering, and to compute the magnitude and characteristics of the user motion. Such algorithms include, but are not limited to, those that implement Kalman Filters, Hidden Markov Models, and the like.

The control application then provides those computed values as input to the video game being played by the user on computing device 30 (box 78). The game utilizes these input values, as well as signals received from the keyboard and/or mouse and the results of one or more go/no-tasks generated by the video game for the user (i.e., the impulsivity score), to provide feedback in a feedback loop to the user regarding the user's performance, as previously described (box 80). Based on the feedback in this feedback loop, the user alters their performance, or maintains their performance (box 82), which is then once again measured by the EEG sensors 22 and motion sensors 24 (box 72), processed by the control application, and used by the game as previously described (boxes 74, 76, 78, 80, 82).

Additionally, as previously stated, the computing device 30 may output the same information used for feedback to the user to the user's profile, which may be stored in a memory device and/or accessible at another computer, for example, so that the user, a parent, a guardian, a teacher, a medical professional, or other similar person can review, manage, and analyze the user's progress. As stated above, the information in these profiles can be utilized, in one or more embodiments, in the calibration of the user's attention and/or motion scores. Further, the user, supervisor, parent, other person with access to this information can personalize the information and feed it back to the control application executing on computing device 30.

To that end, in one embodiment, the control application at computing device 30 analyzes the results of the user's game play while the user is playing the game, associates those results and analysis with the user, and stores that information in a profile (box 84). The control application can then generate various graphical indicators (e.g., graphs, charts, spreadsheets, etc.) based on the analysis (box 86), so that the user and other authorized parties can view the user's progress at maintaining focus, as well as at reducing or controlling their hyperactivity and impulsivity (box 88).

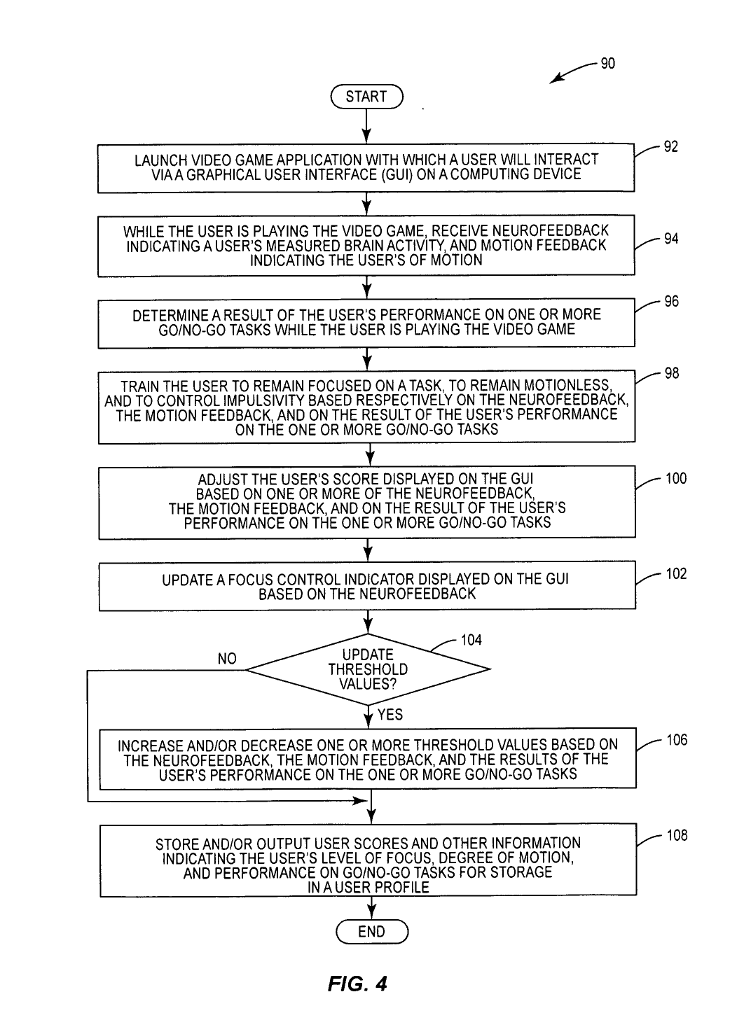

It should be noted that the embodiment of FIG. 3 utilizes a control application that is separate from the video game the user is playing. However, the present disclosure is not so limited. In another embodiment, seen in FIG. 4, the video game is programmed to also perform the functions of the control application.

Method 90 begins when the video game is launched for execution on a computing device, such as computing device 30, for example (box 92). Launching the video game causes the game to generate and display a GUI, such as GUI 40, on a display device associated with computing device 30. Once the video game is operating, the user plays the game. While the user is playing, the video game receives signals from the EEG device 20 worn by the user. The signals include neurofeedback representing the user's measured brain activity and motion feedback representing the user's degree of movement (box 94). In addition, the video game provides one or more go/no-go tasks to be completed by the user while playing the game, and determines how successful the user is at completing those tasks (box 96).

For example, the video game may arbitrarily place various obstacles (e.g., mines 48) in the path of the user's dragon avatar 42 for the user to shoot down. Alternatively, or additionally, the video game may arbitrarily display the other avatars 44 in one of two colors (e.g., green or red) to signify whether they are “good” avatars or “bad” avatars. The bad avatars, as stated above, are to be shot down by the user, while the good avatars are to be ignored by the user. Points are awarded or deducted based on whether the user correctly or incorrectly handles each go/no-go task.

Based on the feedback and the determined go/no-go task results, the video game trains the user to remain focused on a task, to remain as motionless as possible while performing the task, and to control impulsivity (box 98). Particularly, in one embodiment, the video game filters and analyzes the feedback signals received from the EEG device 20, as previously described. The video game then generates and utilizes the data values representing the neurofeedback signals, the motion feedback signals, and the results of the go/no-go tasks to control the functions of the video game, (e.g., the attention score, the motion score, and the impulsivity score) as previously described.

For example, the video game may increase or decrease the user score 54 relative to the user's level of attentiveness, ability to remain still, and ability to successfully complete the go/no-go tasks, as indicated by the neurofeedback, the motion feedback, and the result of the user's performance on the one or more go/no-go tasks, respectively (box 100). Additionally, or alternatively, the video game may dynamically adjust the focus control 56 on GUI 40 to indicate the increasing (or decreasing) focus level for the user (box 102). In another example, as previously described, the velocity and/or the stability of the dragon avatar 42 may be increased and/or decreased based on the neurofeedback and motion feedback.

There are a number of ways to accomplish these functions according to the present embodiments. In one embodiment, however, the video game calculates corresponding values indicating the attention score based on the neurofeedback, the motion score based on the motion feedback, and the impulsivity score based on whether the user successfully completed a go/no-go task during game play. These values are then compared to respective predetermined threshold values. Values that exceed their corresponding thresholds will result in an increase to the user's score, or will cause the dragon avatar 42 to fly faster or have increased stability, for example, while values that are lower than their corresponding thresholds will result in a decrease to the user's score, or will cause the dragon avatar 42 to fly slower or have decreased stability.

Regardless of what particular functions are controlled, however, the present embodiments provide for the dynamic updating of the predetermined threshold values based on how the user is doing. Thus, as seen in FIG. 4, the video game is configured to determine whether to update the threshold values as the user is playing the game (box 104). This decision may be made, for example, based on the comparisons with the various thresholds over time. That is, if the comparisons indicate that the user is losing focus over some period of time, the threshold value associated with the focus level is decreased. If the comparisons indicate that the user is more attentive, the threshold value is increased. A similar process occurs with respect to increasing and decreasing the predetermined threshold values associated with user movement. That is, the threshold values are dynamically increased and decreased while the user is playing the game to ensure that the game play adjusts with the user's movement (box 106).

As with the previous embodiments, the video game may store and/or output the user's scores and other information indicating the user's level of focus, movement, and ability to control their impulsiveness while the user played the video game (box 108). This information may then be utilized in various reports, graphs, and other such indicators representing the user's progress.

As stated above, the present disclosure is not limited to embodiments in which the sensors 22, 24 are integrated into the EEG device 20. For example, in some cases, the EEG device 20 may not be equipped with motion sensors 24. Therefore, some embodiments of the present disclosure utilize another sensor disposed at another device, such as a camera, for example, that is capable of measuring user motion.

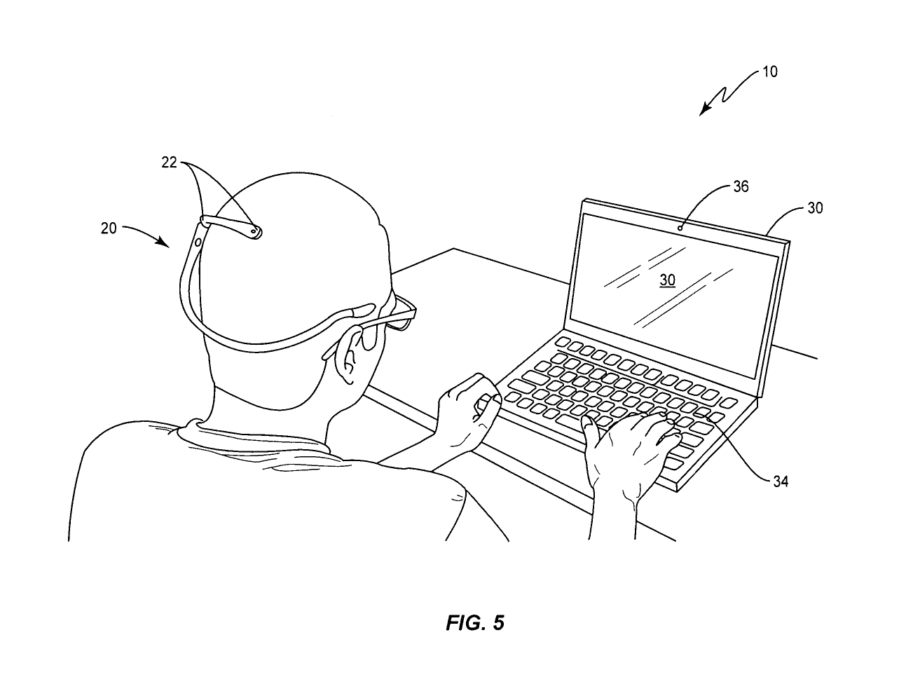

FIG. 5 is a perspective view illustrating one such embodiment of system 10 in which the EEG device 20 worn by the user comprises EEG sensors 22. The motion sensors, however, comprises a camera 36, such as a web cam, for example, associated with the computing device 30 on which the user is playing a game. In these embodiments, the control application executing on the computing device 30 could be configured to control camera 36 to periodically capture images of the user while the user is playing the video game displayed on display device 32. These images would then be analyzed at the computing device 30 using any means known in the art to detect and measure eye movement, body positioning, head movement, and the like, and to compute a motion score for input into the video game as previously described.

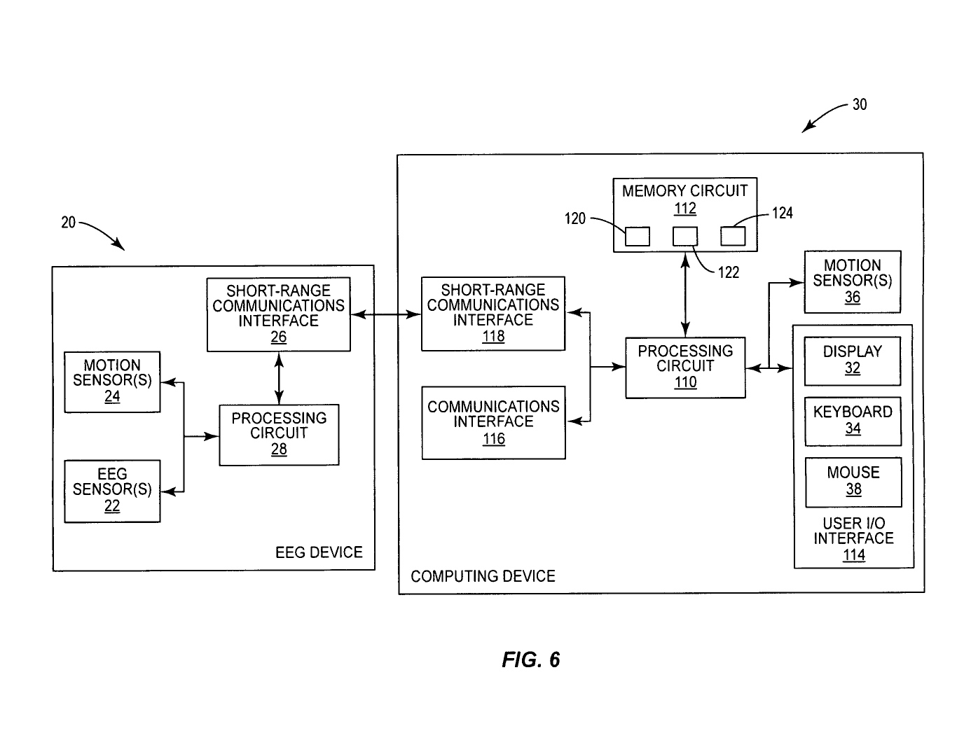

FIG. 6 is a block diagram illustrating some exemplary functional components of an EEG device 20 and a computing device 30. As seen in FIG. 6, the EEG device 20 comprises the EEG sensors 22, and in some embodiments, the motion sensors 24, and the short-range communications interface 26, as previously described. Additionally, however, the EEG device 20 may also comprise a processing circuit 28.

The processing circuit 28 may comprise, for example, one or more microprocessors, hardware circuits, firmware, or a combination thereof. In the exemplary embodiments disclosed herein, processing circuit 28 is configured to receive signals from one or both of the sensors 22, 24, and control the short-range communications interface 26 to transmit those signals to the computing device 30, using BLUETOOTH, for example, as previously described. Additionally, the processing circuit 28 may be configured to filter these signals to remove unwanted interference, as previously described. In some embodiments, the processing circuit 28 may incorporate a memory circuit, or have access to a memory circuit, that stores instructions and data to control the functioning of processing circuit 28.

The computing device 30 comprises a processing circuit 110, a memory circuit 112, a user input/output (I/O) interface 114, a communications interface 116, and a short-range communications interface 118. The processing circuit 110 may be implemented by one or more microprocessors, hardware, firmware, software, or a combination thereof, and generally controls the operation and functions of computing device 30 according to appropriate standards. Such operations and functions include, but are not limited to, executing an application program with which a user may interact, such as a video game.

Additionally, the processing circuit 110 may be configured to implement logic and instructions of a control application 120 stored in memory circuit 112 to perform the functionality of the embodiments of the present disclosure, as previously described. Such functions include, but are not limited to, the receipt of information from the sensors 22, 24 via the short-range communications interface 118, and/or from motion sensor(s) 36, the filtering of this information, if necessary, to remove unwanted interference, the analysis of that information to compute attention and/or motion scores, and to input those scores into the application program to provide feedback to the user in a feedback loop regarding the user's ability to maintain focus and stay still, as previously described.

Memory circuit 112 may comprise any non-transitory, solid state memory or computer readable storage media known in the art. Suitable examples of such media include, but are not limited to, ROM, DRAM, Flash, or a device capable of reading computer-readable storage media, such as optical or magnetic media. The memory circuit 62 stores programs and instructions, such as the control application 120, that controls the processing circuit 110 as stated above. In addition, the memory circuit 112 also stores the application program 122 (e.g., the video game) with which the user interacts, and in some embodiments, one or more of the user profiles 124 previously described. As previously described, the control application 120 and the application program 122 may be implemented as separate application programs that communicate with each other, or as a single application program.

As seen in FIG. 6, the memory circuit 112 and the processing circuit 110 are shown as separate devices that communicate via a bus. However, those of ordinary skill in the art should appreciate that the present disclosure is not limited to this architecture. In other embodiments, the processing circuit 110 may incorporate the memory circuit 112, and thus, the two may form a single circuit.

The User I/O interface, as previously stated, comprises components with which the user can interact with and control the operation of the computing device 30. As seen in FIG. 6, such components include display device 32, keyboard 34, and mouse 38. Additionally, in embodiments where EEG device 20 may not have a motion sensor 24, the computing device 30 may comprise its own motion sensor 36, such as a camera, for example, that is configured to capture images of the user for use in an analysis of the user's motion while playing the video game, as previously described.

The communications interface 116 comprises a transceiver or other communications interface that facilitates communications with one or more remote devices over a communications network, such as the Internet and/or a wireless communications network. Those of ordinary skill in the art will appreciate that the communications interface 116 may be configured to communicate with such remote devices using any protocol known in the art.

The short-range communications interface 118 comprises a transceiver configured to transmit data to, and receive data from, the short-range transceiver 26 of EEG device 20. Thus, the short-range communications interface 118 may comprise a BLUETOOTH transceiver that communicates information with the EEG device 20 using the well-known BLUETOOTH protocol. However, other protocols that are known in the art are also suitable for use by the short-range communications interface 118.

Thus, in one embodiment, the present disclosure provides a method for improving cognitive function or treating a psychological or behavioral disorder. The method is performed at a computing device communicatively connected to one or more sensors and comprises executing an interactive application program with which a user interacts. While the user interacts with the application program, the computing device receives signals from the one or more sensors. The signals indicate the user's brain activity and amount of motion while the user interacts with the application program. Based on the received signals, the computing device computes an attention score indicating the user's level of attention while the user interacts with the application program, as well as a motion score indicating the relative amount of user motion while interacting with the application program. These scores are then fed back into the application program in a feedback loop to control the execution of the application program and provide feedback to the user.

The present disclosure may, of course, be carried out in other ways than those specifically set forth herein without departing from essential characteristics of the disclosure. For example, the previous embodiments illustrate the present disclosure as implemented using a video game. However, the present disclosure is not so limited. The methods and devices described herein may be integrated into other attention training protocols, including computer-based cognitive training tasks including, but not limited to, those used by LUMOSITY or COGMED. Additionally, embodiments of the present disclosure may expose the attention scores, motion scores, and other data for access by third-party software via Application Programming Interface (API) calls.

Additionally, the previous embodiments describe the present disclosure in terms of three different forms of feedback: neurofeedback, motion feedback, and impulsivity feedback. However, those of ordinary skill in the art should appreciate that not all three forms of feedback are required by the present embodiments to train a user as previously described. In another embodiment, for example, the previously described functions of the video game application are controlled utilizing only the motion feedback and the impulsivity feedback (i.e., the results of the user's performance on the go/no-go tasks) as input, while in other embodiments, the video game functions are controlled utilizing only the neurofeedback and the impulsivity feedback as input. Regardless of the number and type of inputs, however, data values representing such feedback are collected while the user controls objects generated by the video game, and subsequently utilized by the present embodiments to control the operation of the those objects within the video game. The output seen by the user serves as a psychological reinforcement of desired behavior.

Therefore, the present embodiments are to be considered in all respects as illustrative and not restrictive, and all changes coming within the meaning and equivalency range of the appended claims are intended to be embraced therein.

1. A computer-implemented method for treating a psychological or behavioral disorder, the method comprising:
executing a video game application on a computing device, wherein the video game application generates a virtual environment for display to a user, and one or more objects that are controllable by the user within the virtual environment;
while the user interacts with the video game application:
receiving neurofeedback indicating the user's concentration level while the user is controlling the one or more objects;
receiving motion feedback indicating the user's motion while the user is controlling the one or more objects; and
while the user is controlling the one or more objects, determining the user's performance on one or more go/no-go tasks generated by the video game application, wherein the go/no-go tasks distract the user from concentrating on controlling the one or more objects;
generating input parameters for the video game application based on the neurofeedback, the motion feedback, and the user's performance on the one or more go/no-go tasks; and
inputting the input parameters into the video game application, wherein the input parameters control the one or more objects to train the user to remain focused, to remain motionless, and to control impulsivity, while controlling the one or more objects.

2. The computer-implemented method of claim 1 wherein generating input parameters for the video game application comprises:
filtering the neurofeedback and the motion feedback to remove noise;
performing a spectral analysis on the filtered neurofeedback and the filtered motion feedback; and
generating the input parameters for the video game application based on a result of the spectral analysis.

3. The computer-implemented method of claim 2 wherein performing a spectral analysis on the filtered neurofeedback comprises:
determining the user's peak alpha frequency;
generating a plurality of a plurality of electroencephalography (EEG) domains based on the user's peak alpha frequency;
converting the filtered neurofeedback into corresponding frequencies while the user controls the one or more controllable objects; and
binning each frequency into one of the plurality of EEG domains.

4. The computer-implemented method of claim 3 wherein generating the input parameters for the video game application based on a result of the spectral analysis comprises generating the input based on the frequencies in one or more of the EEG domains.

5. The computer-implemented method of claim 3 wherein the plurality of EEG domains comprise a beta domain and a theta domain, and wherein generating the input parameters for the video game application based on a result of the spectral analysis comprises computing a beta/theta ratio based on the frequencies in the theta and beta domains.

6. The computer-implemented method of claim 1 wherein the input parameters comprise a plurality of input parameters, and wherein the method further comprises:
controlling a velocity of an object with a first input parameter, wherein the first input parameter is generated based on the neurofeedback; and
controlling a stability of the object with a second input parameter, wherein the second input parameter is generated based on the motion feedback.

7. The computer-implemented method of claim 1 wherein the video game application generates a graphical user interface (GUI) to display the virtual environment and the one or more controllable objects to the user, and wherein the method further comprises:
calculating an attention score based on the neurofeedback, wherein the attention score represents the user's concentration level while the user is controlling the one or more objects;
calculating a motion score based on the motion feedback, wherein the motion score represents the user's motion while the user is controlling the one or more objects;
calculating an impulsivity score based on a result of the user's performance on the one or more go/no-go tasks.

8. The computer-implemented method of claim 7 further comprising updating one or more indicator controls on the GUI based on the attention score, the motion score, and the impulsivity score.

9. The computer-implemented method of claim 7 further comprising:
comparing one or more of the attention score, the motion score, and the impulsivity score to corresponding threshold values;
controlling at least one of a function and a characteristic a selected controllable object based on a result of the comparisons;
dynamically increasing or decreasing each corresponding threshold value based at least in part on the result of the comparisons while the user interacts with the video game application.

10. A computing device configured for treating a psychological or behavioral disorder, the computing device comprising:
a communications interface circuit configured to receive neurofeedback and motion feedback for a user from corresponding first and second sensor devices; and
a processing circuit configured to:
execute a video game application, wherein the video game application generates a virtual environment for display to a user, and one or more objects that are controllable by the user within the virtual environment;
while the user interacts with the video game application:
receive the neurofeedback indicating the user's concentration level while the user is controlling the one or more objects;
receive the motion feedback indicating the user's motion while the user is controlling the one or more objects; and
while the user is controlling the one or more objects, determine the user's performance on one or more go/no-go tasks generated by the video game application, wherein the go/no-go tasks distract the user from concentrating on controlling the one or more objects;
generate input parameters for the video game application based on the neurofeedback, the motion feedback, and the user's performance on the one or more go/no-go tasks; and
input the input parameters into the video game application, wherein the input parameters control the one or more objects to train the user to remain focused, to remain motionless, and to control impulsivity, while controlling the one or more objects.

11. The computing device of claim 10 wherein the processing circuit is further configured to:
filter the neurofeedback and the motion feedback to remove noise;
perform a spectral analysis on the filtered neurofeedback and the filtered motion feedback; and
generate the input parameters for the video game application based on a result of the spectral analysis.

12. The computing device of claim 11 wherein the processing circuit is further configured to:
determine the user's peak alpha frequency;
generate a plurality of a plurality of electroencephalography (EEG) domains based on the user's peak alpha frequency;
convert the filtered neurofeedback into corresponding frequencies while the user controls the one or more controllable objects; and
bin each frequency into one of the plurality of EEG domains.

13. The computing device of claim 12 wherein the processing circuit is further configured to generate the input parameters for the video game application based on the frequencies in one or more of the EEG domains.

14. The computing device of claim 12 wherein the plurality of EEG domains comprises a theta domain and a beta domain, and wherein to generate the input parameters for the video game application based on a result of the spectral analysis, the processing circuit is further configured to compute a beta/theta ratio based on the frequencies in the theta and beta domains.

15. The computing device of claim 10 wherein the input parameters comprise a plurality of input parameters, and wherein the processing circuit is further configured to:
control a velocity of an object based on a value of a first input parameter, wherein the first input parameter is generated based on the neurofeedback; and
control a stability of the object based on a value of a second input parameter, wherein the second input parameter is generated based on the motion feedback.

16. The computing device of claim 10 wherein the processing circuit is further configured to:
generate a graphical user interface (GUI) to display the virtual environment and the one or more controllable objects to the user;
calculate an attention score based on the neurofeedback, wherein the attention score represents the user's concentration level while the user is controlling the one or more objects;
calculate a motion score based on the motion feedback, wherein the motion score represents the user's motion while the user is controlling the one or more objects; and
calculate an impulsivity score based on a result of the user's performance on the one or more go/no-go tasks.

17. The computing device of claim 16 wherein the processing circuit is further configured to update one or more indicator controls on the GUI based on the attention score, the motion score, and the impulsivity score.

18. The computing device of claim 16 wherein the processing circuit is further configured to:
compare one or more of the attention score, the motion score, and the impulsivity score to corresponding threshold values;
control at least one of a function and a characteristic a selected controllable object based on a result of the comparisons;
dynamically increase or decrease each corresponding threshold value based at least in part on the result of the comparisons while the user interacts with the video game application.

19. A computer-implemented method for treating a psychological or behavioral disorder while the user interacts with a video game application executing on a computing device, wherein the video game application generates a virtual environment for display to a user and one or more objects that are controllable by the user within the virtual environment, the method comprising:
while the user is controlling the one or more objects:
receiving neurofeedback from a first sensor device indicating the user's concentration level;
receiving motion feedback from a second sensor device indicating the user's motion while the user is controlling the one or more objects; and
determining the user's performance on one or more go/no-go tasks generated by the video game application, wherein the go/no-go tasks distract the user from concentrating on controlling the one or more objects;
generating input parameters based on the neurofeedback, the motion feedback, and the user's performance on the one or more go/no-go tasks; and
inputting the input parameters into the video game application, wherein the input parameters control the one or more objects to train the user to remain focused, to remain motionless, and to control impulsivity, while controlling the one or more objects.

20. A computer-implemented method for treating a psychological or behavioral disorder while the user interacts with a video game application executing on a computing device, wherein the video game application generates a virtual environment for display to a user and one or more objects that are controllable by the user within the virtual environment, the method comprising:
while the user is controlling the one or more objects:
receiving motion feedback from a sensor device indicating the user's motion; and
determining the user's performance on one or more go/no-go tasks generated by the video game application, wherein the go/no-go tasks distract the user from concentrating on controlling the one or more objects;
generating input parameters based on the motion feedback and the user's performance on the one or more go/no-go tasks; and
inputting the input parameters into the video game application, wherein the input parameters control the one or more objects to train the user to remain motionless, and to control impulsivity, while controlling the one or more objects.
